(19) United States
(12) Patent Application Publication
(10) Pub. No.: US 2005/0072913 A1
(43) Pub. Date: Apr. 7, 2005

(54) Laser scanning microscope

(76) Inventors: Ralph Lange, Jena (DE); Thomas Mehner, Kleinromstedt (DE); Stefan Wilhelm, Jena (DE); Ralf Wolleschensky, Apolda (DE); Ralf Engelmann, Jena (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/888,187

(22) Filed: Jul. 9, 2004

(30) Foreign Application Priority Data
Jul. 11, 2003 (DE) 103 32 063.6

(51) Int. Cl. H01J 3/14

(52) U.S. Cl. 250/234

(57) ABSTRACT

Laser scanning microscope with at least four separate input-coupling locations for wavelength ranges in the UV region, in the visible region and in the IR region, and advantageously with at least two individually displaceable collimators for achieving a maximum flexibility in the selection of dyes and evaluating methods, preferably for displaying cellular calcium and the associated receptors in living tissue over long periods of time (time lapse) with infrared lasers and UV lasers, wherein fluorescence detection and uncaging are applied, for releasing drugs (uncaging) and IR illumination with transmission detection, for the realization of applications with fluorescing proteins of the (G)FP family, including photoactivation of GFP and CFP/YFP-FRET, for the use of CY 5.5 dyes in the dark-red region (laser 675 nm) for tumor research.

### CROSS-REFERENCE TO RELATED APPLICATION

This application claims priority of German Application No. 103 32 063.6, filed Jul. 11, 2003, the complete disclosure of which is hereby incorporated by reference.

### BACKGROUND OF THE INVENTION

a) Field of the Invention

Irradiation, in particular of biological specimens, with a plurality of laser lines allows cells to be safely observed by IR light and at the same time allows drugs to be released pointwise by UV light (uncaging). Observation can be carried out with transmission detection as well as with incident-light fluorescence detection using the laser scanning microscope.

The invention is directed to the combined use of such widely separated wavelengths which allows novel scientific detection methods above all for investigating the physiology of living cells and nerve cells and for the functional architecture of complex brain areas.

b) Description of the Related Art

Leite et al., Gastroenterology 2002 Feb. 122(2):415-27, describe the displaying of cellular calcium and the associated receptors in living tissue over long periods of time (time lapse) using the laser scanning microscope with infrared lasers and UV lasers, wherein fluorescence detection and uncaging are applied.

Dodt et al., Neuroreport 2003 Mar. 24; 14(4):623-7, describe the displaying of synaptic connections in the cortex of rats, wherein a mixture of methods using electrical derivations (patch clamp) and laser scanning microscopy with UV lasers for releasing drugs (uncaging) and IR illumination with transmission detection are applied. In addition, infrared lasers are also used to stimulate nerve cells.

Application examples V (visible light): Hanson and Kohler, J Exp. Bot. 2001 April; 52(356):529-39, describe possible modern applications of the (G)FP family, including photoactivation of GFP and CFP/YFP-FRET (optimal: 432 nm).

Patterson and Lippincott-Schwartz, Science 2002 Sep. 13; 297(5588):1873-7, describe a new GFP which can be photoactivated with laser lines 405/413 nm. Applications in cellular and developmental biology.

Application examples FR (far red range): Petrovsky et al., Cancer Res 2003 Apr. 15; 63(8): 1936-42, describe the use of CY 5.5 dyes in the dark-red region (laser 675 nm) for tumor research, wherein the long wavelength offers advantages with respect to gentle treatment of tissue and optical penetration depth.

Device solutions for laser scanning microscopes are known in which a maximum of three input ports are realized for illumination with different wavelengths. DE 19702753 A1 describes in detail a LSM beam path with two input ports.

Further, it is prior art that there are no available microscope objectives which are corrected for chromatic longitudinal aberrations over the entire spectral range from UV to IR. This means that the focal planes for different spectral regions lie more or less in different z-planes so that no satisfactory imaging would be achievable with respect to the requirements of confocal microscopy.

### ARRANGEMENT OF THE INVENTION

It is generally required for confocal laser scanning microscopy to couple the different laser light sources from the UV to IR ranges into the device by polarization-preserving single-mode fibers. For this purpose, the application bandwidth of LSM should be expanded.

It is clear from the applications described under 1) that laser wavelengths of 405 nm, 413 nm, 432 nm and 675 nm must be available in addition to laser wavelengths in the V, VIS and IR ranges in order to cover the full application bandwidth.

According to the prior art in the field of fiber optics, these wavelengths can be advantageously transported by means of polarization-preserving single-mode fibers by dividing into the following ranges:
1. 350 nm-380 nm (UV)/laser lines 351 nm to 380 nm
2. 400 nm-445 nm (V)/laser lines 400 nm to 442 nm
3. 455 nm-635 nm (VIS)/laser lines 458 nm to 635 nm
4. 650 nm-680 nm (FR)/laser lines 650 nm, 675 nm
5. 690 nm-1100 nm (IR)/tunable TiSa laser.

The spectral gap between the wavelength regions is advantageous for ensuring a separation of the spectral regions by means of corresponding beam splitters (minimum edge steepness of the beam unifiers in the range of 10 nm to 20 nm).

In a corresponding manner, preferably five or more fiber coupling ports K1-K5 are used for achieving the application requirements. At the same time, every coupling port can have collimating optics KO1-5 which are displaceable in z-direction in order to collimate the laser light exiting divergently from every source point (respective fiber end face) and in order to image the fiber end faces in a single focal plane in an optimal manner depending on the microscope objective and wavelengths that are used. Further, the described division into five spectral regions is advantageous insofar as a broad palette of objectives with a wide variety of chromatic correction can be made use of for confocal microscopy in this way. The number of coupling ports can also be reduced, e.g., to four, with an available fiber in the wavelength range of 400 nm to 640 nm. However, it is advantageous to arrange more than three coupling ports because this makes it possible to use optics with good chromatic correction.

The five fiber coupling ports of the arrangement described herein are to be suitably arranged in such a way that the distance to the objective pupil is identical for all source points (fiber end faces) in order to be able to image them uniformly in the objective pupil in a suitable manner and to achieve optimal conditions with respect to adjusting sensitivity and stability.

Further, imaging in the objective pupil has the advantage that no substantial change in illumination takes place in the image when the collimator is displaced in z-direction. The unification of beams to form a common beam is carried out for reasons of long-term stability by means of fixedly installed, non-adjustable dichroic layers. The beam unifiers are located in the parallel or, depending on the z-position of the collimating optics, slightly convergent or divergent beam path. For this purpose, the spectral regions are to be arranged in such a way that the dichroic layers can preferably be constructed as long-pass dichroic layers or short-pass dichroic layers and, in this way, production is simplified and the sensitivity of the spectral characteristics to changes in environmental conditions are kept at a minimum because of the less complex layer construction compared to single bandpasses or multiple bandpasses.

### BRIEF DESCRIPTION OF THE DRAWINGS

In the drawings:

FIG. 1 shows the arrangement of the coupling port in individual collimators generally; and

FIG. 2 shows the arrangement of the invention for five fiber optic coupling ports.

### DESCRIPTION OF THE PREFERRED EMBODIMENTS

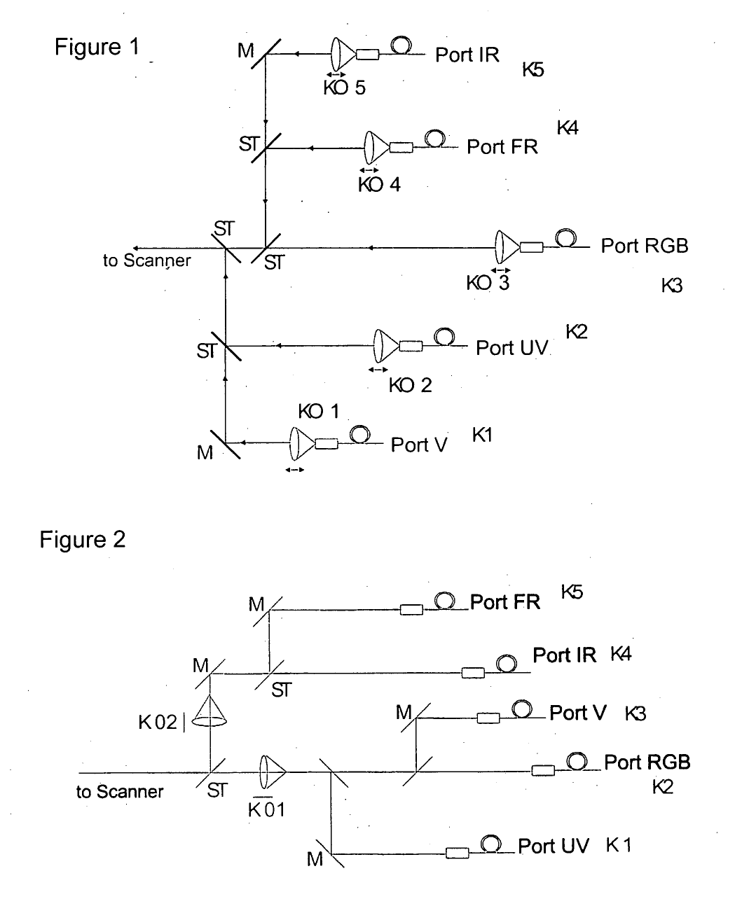

FIG. 1 shows the arrangement of the coupling port in individual collimators for every port and the beam unification by means of the beam splitters ST and mirrors M.

When the microscope objectives are chromatically corrected in a corresponding manner, it is likewise possible to combine individual spectral ranges and to use only one collimating lens for the UV/V, RGB and FR/IR spectral regions.

In further developments in the field of fiber technique, it is likewise possible to combine individual fiber coupling ports such as K2 and K3 or K1 and K3 or K2 and K5 or K2, K3 and K5. This has the advantage of a more compact construction and a reduced mechanical effort, but with limited functionality. In this case, the beam unifiers ST are located in the highly divergent beam path between the fiber end faces and movable collimating optics KO1 and KO2.

FIG. 2 shows the arrangement for five fiber coupling ports schematically.

While the foregoing description and drawings represent the present invention, it will be obvious to those skilled in the art that various changes may be made therein without departing from the true spirit and scope of the present invention.

1-8. (canceled)

9. A laser scanning microscope comprising at least four separate input-coupling locations for wavelength ranges in the UV region, visible region and IR region.

10. A laser scanning microscope comprising at least four input-coupling locations for purposes of illumination with laser light, and at least two individually displaceable collimators for achieving a maximum flexibility in the selection of dyes and evaluating methods.

11. A laser scanning microscope for displaying cellular calcium and the associated receptors in living tissue over long periods of time (time lapse) comprising infrared lasers and UV lasers, wherein fluorescence detection and uncaging are applied, comprising at least four separate input-coupling locations for UV, V, VIS, FR and IR radiation.

12. A laser scanning microscope with UV lasers for releasing drugs (uncaging) and IR illumination with transmission detection, comprising:
at least four separate input-coupling locations for UV, V, VIS, FR and IR radiation; and
a laser scanning microscope for the realization of applications with fluorescing proteins of the (G)FP family, including photoactivation of GFP and CFP/YFP-FRET, comprising at least four separating input-coupling locations for UV, V, VIS, FR, IR radiation.

13. A laser scanning microscope for the use of CY 5.5 dyes in the dark-red region (laser 675 nm) for tumor research, comprising at least four separate input-coupling locations for UV, V, VIS, FR, IR radiation.

14. A laser scanning microscope according to claim 9, comprising at least four input-coupling locations for the following wavelength ranges:
350 nm-380 nm (UV)
400 nm-445 nm (V)
455 m-635 nm (VIS)
650 nm-680 nm (FR)
690 nm-1100 nm (1R).

15. The laser scanning microscope according to claim 9, wherein the coupling in is carried out by means of at least one light-conducting fiber.

16. The laser scanning microscope according to claim 9, wherein a wavelength adaptation of the focus position is carried out by means of displaceable collimating optics.
